(19) United States
(12) Patent Application Publication
(10) Pub. No.: US 2012/0219847 A1
(43) Pub. Date: Aug. 30, 2012

(54) POUCH TYPE BATTERY AND ITS MANUFACTURING METHOD

(75) Inventors: Kisung Hong, Yongin-si (KR); Younghoon Kim, Yongin-si (KR)

(73) Assignee: Samsung SDI Co., Ltd., Yongin-si (KR)

(21) Appl. No.: 13/196,745

(22) Filed: Aug. 2, 2011

Related U.S. Application Data
(60) Provisional application No. 61/446,413, filed on Feb. 24, 2011.

(51) Int. Cl. H01M 2/02; H01M 2/20

(52) U.S. Cl. 429/163; 29/623.1; 29/623.4; 29/623.2

(57) ABSTRACT

Provided are a lithium polymer battery and a method of manufacturing the lithium polymer battery. The lithium polymer battery comprises: an electrode assembly comprising a positive electrode, a negative electrode and a separator; a pouch enclosing the electrode assembly, the pouch comprising a first panel and a second panel generally opposing the first panel, the first panel comprising a first main surface, the second panel comprising a second main surface opposing the first main surface, the pouch further comprising a first step formed in the first panel in a perimeter thereof and stepped from the first main surface toward the second main surface, the first step comprising a first step surface generally parallel to the first main surface; and an insulation tape placed on the first step surface and comprising a first tape surface over the first step surface and facing away from the first step surface, wherein the first main surface is generally planar throughout, and the insulation tape is not placed over the first main surface, and wherein the first step and the insulation tape are sized such that the first tape surface is at a level not substantially higher than the first main surface

### RELATED APPLICATIONS

This application claims the benefit of U.S. Provisional Patent Application No. 61/446,413, filed on Feb. 24, 2011, with the United States Patent and Trademark Office, the disclosure of which is incorporated herein in its entirety by reference.

### BACKGROUND

1. Field

Embodiments relate to a lithium polymer battery and a method of manufacturing the lithium polymer battery.

2. Description of the Related Technology

In a lithium polymer battery, a separator is typically disposed between positive and negative electrode plates as an ion transfer medium (that is, electrolyte) and a separating member, for example, in a lithium ion battery (hereinafter, an assembly of a positive electrode plate, a negative electrode plate, and a separator will be referred to as an “electrode assembly”). Such a separator is typically &limed of a gel-type polymer electrolyte. For example, a separator may be formed by impregnating a polymer with electrolyte to improve ion conductivity.

A lithium polymer battery may include a flexible pouch shape. In such a pouch type battery, an electrode assembly formed by stacking a positive electrode, a separator, and a negative electrode may be disposed in a pouch, or an electrode assembly formed by stacking and winding a positive electrode, a separator, and a negative electrode may be disposed in a pouch. Edges of upper and lower films of the pouch are typically thermally bonded. The pouch is generally formed of a multilayer film including a metal foil layer and a synthetic resin layer (polymer layer) covering the metal foil layer. The metal foil layer is generally formed of aluminum. The polymer layer forming an inner layer of the pouch can protect the metal foil layer from electrolyte. The polymer film can also prevent a short circuit among the positive electrode, the negative electrode, and electrode tabs. If edges of the pouch are not insulated, the metal foil layer (middle layer) of the pouch may be exposed. In this case, a short circuit may occur between the exposed metal foil layer and a conductor of an external device.

### SUMMARY

An aspect of the present invention provides a lithium polymer battery comprising: an electrode assembly comprising a positive electrode, a negative electrode and a separator; a pouch enclosing the electrode assembly, the pouch comprising a first panel and a second panel generally opposing the first panel, the first panel comprising a first main surface, the second panel comprising a second main surface opposing the first main surface, the pouch further comprising a first step formed in the first panel in a perimeter thereof and stepped from the first main surface toward the second main surface, the first step comprising a first step surface generally parallel to the first main surface; and an insulation tape placed on the first step surface and comprising a first tape surface over the first step surface and facing away from the first step surface, wherein the first main surface is generally planar throughout, and the insulation tape is not placed over the first main surface, wherein the first step and the insulation tape are sized such that the first tape surface is at a level not substantially higher than the first main surface.

A method of making a battery, the method comprising: providing a pouch for enclosing an electrode assembly, the pouch comprising a first panel and a second panel generally opposing the first panel; forming a first step in the first panel to provide a first main surface and a first step surface stepped toward the second panel, wherein the first main surface is substantially planar throughout; and placing an insulation tape on the first step surface such that the insulation tape has a first tape surface facing away from the first step surface, wherein the insulation tape is not placed over the first main surface, wherein the first step and the insulation tape are sized such that the first tape surface is at a level not substantially higher the first main surface.

### BRIEF DESCRIPTION OF THE DRAWINGS

FIG. 1 is a perspective view illustrating a lithium polymer battery according to an embodiment;

FIG. 2 is a sectional view of the lithium polymer battery taken along line I-I′ of FIG. 1;

FIG. 3 is an enlarged sectional view illustrating portion (3) of FIG. 2;

FIG. 4 is a perspective view illustrating a sealed outer member of the lithium polymer battery illustrated in FIG. 1;

FIG. 5 is a perspective view illustrating a folded state of remaining parts of the sealed outer member of the lithium polymer battery illustrated in FIG. 4;

FIG. 6 is a flowchart for explaining a method of manufacturing a lithium polymer battery according to an embodiment;

FIG. 7 is a sectional view illustrating a lithium polymer battery according to another embodiment, FIG. 7 corresponding to FIG. 2; and

FIG. 8 is an enlarged sectional view illustrating portion (8) of FIG. 7.

### DETAILED DESCRIPTION

Hereinafter, a lithium polymer battery and a method of manufacturing the lithium polymer battery will be described in detail with reference to the accompanying drawings according to certain embodiments.

First, a lithium polymer battery will be described according to an embodiment.

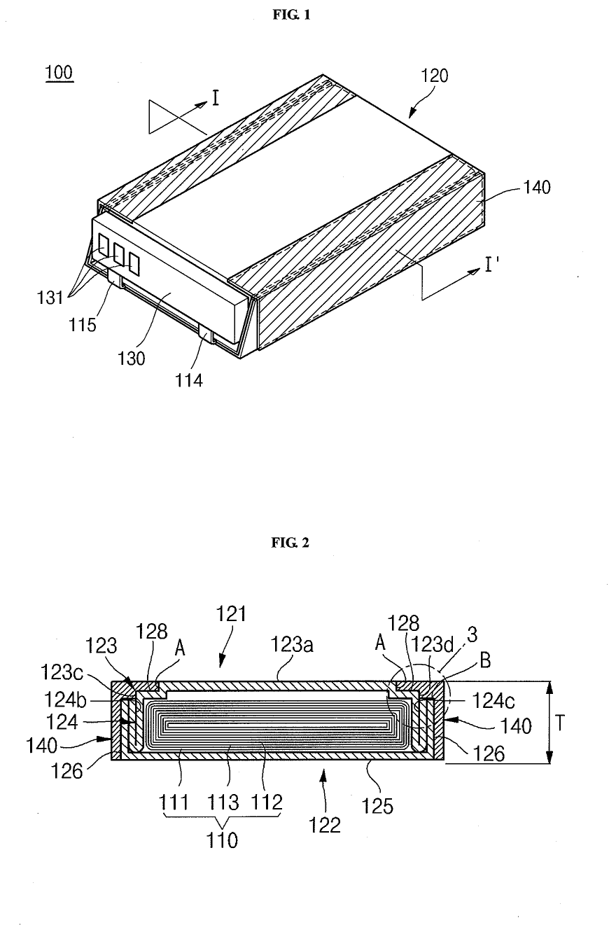

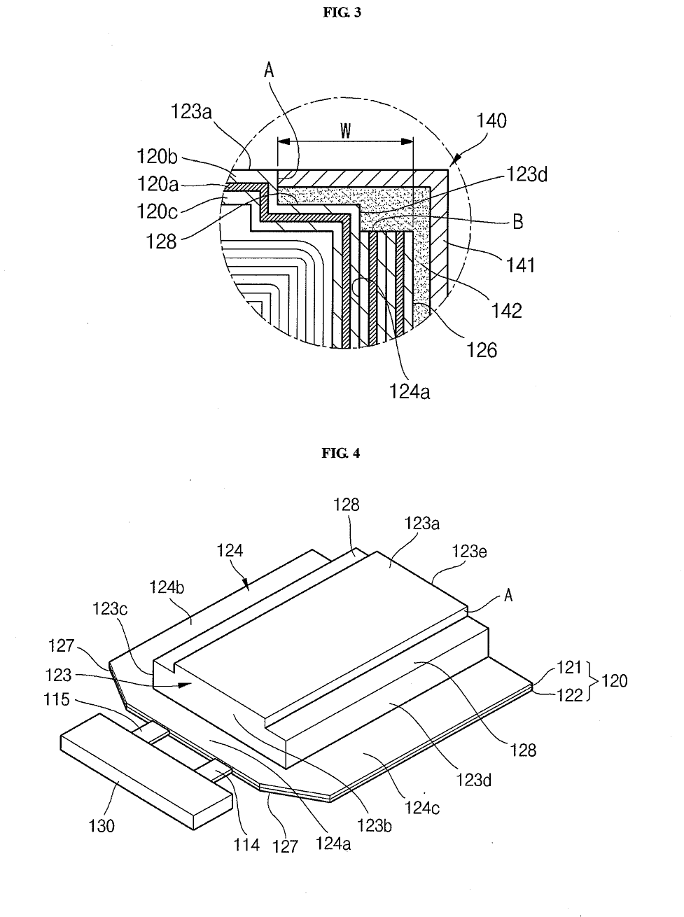

FIG. 1 is a perspective view illustrating the lithium polymer battery 100 according to an embodiment. FIG. 2 is a sectional view of the lithium polymer battery 100 taken along line I-I′ of FIG. 1. FIG. 3 is an enlarged sectional view illustrating portion (3) of FIG. 2. FIG. 4 is a perspective view illustrating a sealed outer member 120 of the lithium polymer battery 100 illustrated in FIG. 1. FIG. 5 is a perspective view illustrating a folded state of the sealed outer member 120 of the lithium polymer battery 100 illustrated in FIG. 4.

As shown in FIGS. 1 through 5, the lithium polymer battery 100 of the current embodiment may include an electrode assembly 110, the outer member 120, a protective circuit module 130, and insulation tapes 140.

The outer member 120 of the lithium polymer battery 100 may be sealed, and upper and lower remaining parts 124 and 126 of the outer member 120 may be folded. The insulation tapes 140 may be attached to edge parts (B) of the folded outer member 120. For attaching the insulation tapes 140 to the edge parts (B), the edge parts (B) are pressed to defined recesses having a depth corresponding to the thickness of the insulation tapes 140. Since the insulation tapes 140 are attached to the pressed edge parts (B), a thickness (T) of the lithium polymer battery 100 is not increased.

The electrode assembly 110 may include a positive electrode plate 111, a separator 113, and a negative electrode plate 112 that are sequentially stacked or wound after being sequentially stacked. A positive electrode tab 114 may be connected to the positive electrode plate 111 and extend outward from the positive electrode plate 111 by a predetermined length, and a negative electrode tab 115 may be connected to the negative electrode plate 112 and extend outward from the negative electrode plate 112 by a predetermined length.

The positive electrode plate 111 may be formed by coating aluminum foil or mesh with a lithium cobalt oxide (positive electrode active material). The negative electrode plate 112 may be formed by coating copper foil with graphite (negative electrode active material). The separator 113 may be formed of a gel type polymer electrolyte. However, the separator 113 is not limited to the gel type polymer electrolyte. In addition, the current embodiment is not limited to the positive electrode plate 111, the positive electrode active material, the negative electrode plate 112, and the negative electrode active material.

The positive electrode tab 114 may be formed of aluminum and may be connected to a non-coating portion of the positive electrode plate 111. The positive electrode tab 114 may protrude from a side of the outer member 120. The negative electrode tab 115 may be formed of copper and may be connected to a non-coating portion of the negative electrode plate 112. The negative electrode tab 115 may protrude from a side of the outer member 120. However, the current embodiment is not limited to the above-listed materials.

The outer member 120 may include a plurality of layers. The outer member 120 may include a metal thin film 120a and insulation layers 120b and 120c formed on both sides of the metal thin film 120a.

The metal thin film 120a may be formed of steel, stainless steel, aluminum, or an equivalent thereof. However, the material of the metal thin film 120a is not limited to the above-mentioned materials.

The insulation layers 120b and 120c may include an outer insulation layer 120b and an inner insulation layer 120c.

The outer insulation layer 120b may foam an outer surface of the outer member 120. The outer insulation layer 120b may be formed of one of nylon, polyethylene terephthalate (PET), and an equivalent thereof. However, the material of the outer insulation layer 120b is not limited to the above-mentioned materials.

The inner insulation layer 120c forms an inner surface of the outer member 120. The inner insulation layer 120c may be formed of one of chlorinated polypropylene (CPP) and an equivalent thereof. However, the material of the inner insulation layer 120c is not limited to the above-mentioned materials.

The outer member 120 may include an upper outer member 121 and a lower outer member 122. Edges of the upper outer member 121 and the lower outer member 122 may be bonded together, and the other edges of the upper outer member 121 and the lower outer member 122 may not be bonded so that the electrode assembly 110 can be received.

The upper outer member 121 may include a drawing part 123 and the upper remaining part 124 extending from the drawing part 123. The drawing part 123 can accommodate the electrode assembly 110.

The lower outer member 122 may include a finishing part 125 and the lower remaining part 126. The finishing part 125 may cover the drawing part 123. The lower remaining part 126 corresponds to the upper remaining part 124 of the upper outer member 121. The upper remaining part 124 and the lower remaining part 126 are brought into contact with each other to seal the lithium polymer battery 100.

The drawing part 123 may be formed into a shape corresponding to the shape of the electrode assembly 110. The drawing part 123 can include a top surface 123a having a predetermined area, and side surfaces 123b, 123c, 123d, and 123e extending from the top surface 123a. The depth of the drawing part 123 may be determined by the side surfaces 123b, 123c, 123d, and 123e. In the following description, a side of the lithium polymer battery 100 from which the positive and negative electrode tabs 114 and 115 protrude will be referred to as a “front surface” 123b. Sides of the upper and lower outer members 121 and 122 that are bonded together will be referred to as a “rear surface” 123e. Remaining parts are not formed at the rear surface 123e. The other side surfaces except for the front surface 123b and the rear surface 123e will be referred to as a “first side surface” 123c and a “second side surface” 123d.

The upper remaining part 124 may include a first remaining part 124a extending from the front surface 123b, a second remaining part 124b extending from the first side surface 123c, and a third remaining part 124c extending from the second side surface 123d.

Corners 127 may be formed on both sides of the front surface 123b of the upper remaining part 124. The corners 127 facing the protective circuit module 130 may be diagonally cut. The second remaining part 124b and the third remaining part 124c may be folded and brought into contact with the first side surface 123c and the second side surface 123d, respectively. The heights of the folded second and third remaining parts 124b and 124c may be equal to or less than the heights of the first and second side surfaces 123c and 123d.

The top surface 123a may include stepped parts 128. The top surface 123a has an area corresponding to the size of the electrode assembly 110 accommodated in the drawing part 123.

The stepped parts 128 may be disposed at both sides of the top surface 123a. The insulation tapes 140 may be attached to the stepped parts 128, respectively. The stepped parts 128 may be formed by a pressing process. A depth (A) formed by the pressing process may be substantially equal to the thickness of the insulation tapes 140. Therefore, the insulation tapes 140 may be at a level not substantially higher than the top surface 123a after the insulation tapes 140 are attached to the stepped parts 128.

The protective circuit module 130 may include a protective circuit board. A plurality of semiconductor devices may be disposed on the protective circuit board to detect overcharging, overdischarging, and short circuit of the lithium polymer battery 100. The protective circuit module 130 may include electrode terminal 131 for charge and discharge.

The protective circuit module 130 may be electrically connected to the positive electrode tab 114 and the negative electrode tab 115. The protective circuit module 130 may be easily erected at the front side of the outer member 120 (pouch) by bending the positive and negative electrode tabs 114 and 115 in an L or U shape.

When the protective circuit module 130 is erected, the height of the protective circuit module 130 may be substantially equal to or less than the lateral height of the drawing part 123.

Each of the insulation tapes 140 may include an insulation part 141 and an adhesive part 142.

The insulation part 141 may be formed of a heat-resistant and chemical-resistant material. For example, the insulation part 141 may be formed of a material selected from the group consisting of a polyethylene film, an epoxy film, a polyimide film, a Teflon film, a polyvinyl chloride film, a polyester film, an acetate film, a filament film, an asbestos film, a paper film, and a polypropylene film.

The adhesive part 142 may be formed on a side of the insulation part 141. The adhesive part 142 may include one of an acryl-based adhesive, a silicon-based adhesive, and a rubber-based adhesive.

The insulation tapes 140 may be attached in a reverse L shape. The thickness of the insulation tapes 140 may be about 50 μm or less. The length of the insulation tapes 140 may correspond to the length of the edge parts (B) of the second remaining part 124b and the third remaining part 124c.

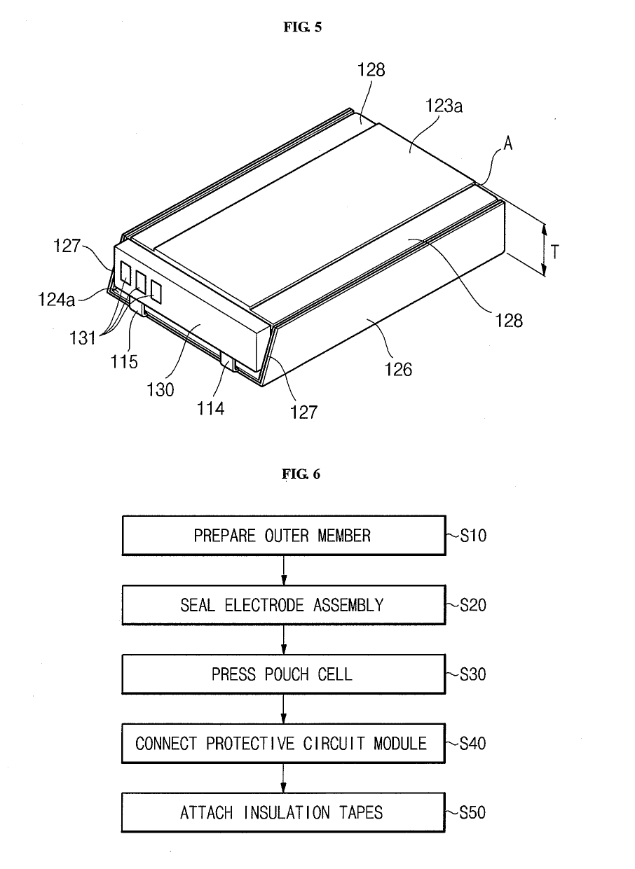

FIG. 6 is a flowchart explaining a method of manufacturing a lithium polymer battery 100 according to an embodiment.

The lithium polymer battery manufacturing method of the current embodiment includes: an operation S10 of preparing an outer member 120; an operation S20 of accommodating and sealing an electrode assembly 110 including positive and negative electrode tabs 114 and 115 in the outer member 120; an operation S30 of pressing both sides of a top surface 123a of a drawing part 123 of the sealed outer member 120 to form recesses heaving a depth corresponding to the thickness of insulation tapes 140; an operation S40 of connecting a protective circuit module 130 to the positive and negative electrode tabs 114 and 115; and an operation S50 of attaching the insulation tapes 140 to both the pressed sides of the top surface 123a of the drawing part 123 of the outer member 120.

In the lithium polymer battery manufacturing method of the current embodiment, after performing the operation S20 of accommodating and sealing the electrode assembly 110 in the outer member 120, the operation S40 of connecting the protective circuit module 130 to the positive and negative electrode tabs 114 and 115, the operation S30 of pressing both sides of the top surface 123a of the drawing part 123 to form recesses heaving a depth corresponding to the thickness of the insulation tapes 140, and the operation S50 of attaching the insulation tapes 140 to both the pressed sides of the top surface 123a may be sequentially performed.

In the outer member preparing operation S10, the outer member 120 is prepared, and the outer member 120 may include an upper outer member 121 and a lower outer member 122 that can be folded. The upper outer member 121 may include the drawing part 123 and an upper remaining part 124 extending from the drawing part 123. The drawing part 123 may accommodate the electrode assembly 110. The lower outer member 122 may include a finishing part 125 and a lower remaining part 126. The finishing part 125 can cover the drawing part 123.

In the sealing operation S20, the electrode assembly 110 may be accommodated in the drawing part 123, and the upper remaining part 124 of the upper outer member 121 and the lower remaining part 126 of the lower outer member 122 may be brought into contact with each other and sealed. A second remaining part 124b and a third remaining part 124c of the upper remaining part 124 may be folded and brought into contact with a first side surface 123c and a second side surface 123d of the drawing part 123, respectively. At this time, metal thin films 120a may be exposed along edge parts (B) of the second remaining part 124b and the third remaining part 124c.

In the pressing operation S30, both sides of the top surface 123a may be pressed to a depth corresponding to the thickness of the insulation tapes 140. By this, stepped parts 128 can be formed. The insulation tapes 140 may be attached to the stepped parts 128, respectively. A width (W) of an area to which the insulation tape 140 is attached may include the width of the stepped part 128 and the thickness of the folded second remaining part 124b. For example, the width (W) may be about 4 mm to about 5 mm from a lateral edge of the top surface 123a of the drawing part 123.

In the protective circuit module connecting operation S40, the protective circuit module 130 may be connected to the positive electrode tab 114 and the negative electrode tab 115. The protective circuit module connecting operation S40 may include an operation of bending the positive electrode tab 114 and the negative electrode tab 115 in an L or U shape:

In the insulation tape attaching operation S50, the insulation tapes 140 may be attached to both sides of the top surface 123a. At this time, the insulation tapes 140 may be attached in a manner such that the metal thin films 120a exposed along the edge parts (B) of the second remaining part 124b and the third remaining part 124c are covered with the insulation tapes 140. Each of the insulation tapes 140 may include an adhesive part 142. In the operation S50, first, the insulation tape 140 may be placed toward the stepped part 128. Then, the adhesive part 142 may be attached to the stepped part 128. The insulation tapes 140 may be attached in a manner such that the folded second and third remaining parts 124b and 124c are entirely covered with the insulation tapes 140. Although the folded second and third remaining parts 124b and 124c are lower than the drawing part 123, the insulation tapes 140 may be attached to cover the folded second and third remaining parts 124b and 124c. That is, the insulation tapes 140 may be attached to the entire lateral surfaces of the lithium polymer battery 100. If a thickness (T) of the lithium polymer battery 100 is about 2.7 mm, the insulation tapes 140 may be attached to positions spaced at least 2 mm from the top surface 123a of the drawing part 123.

A lithium polymer battery will now be described according to another embodiment.

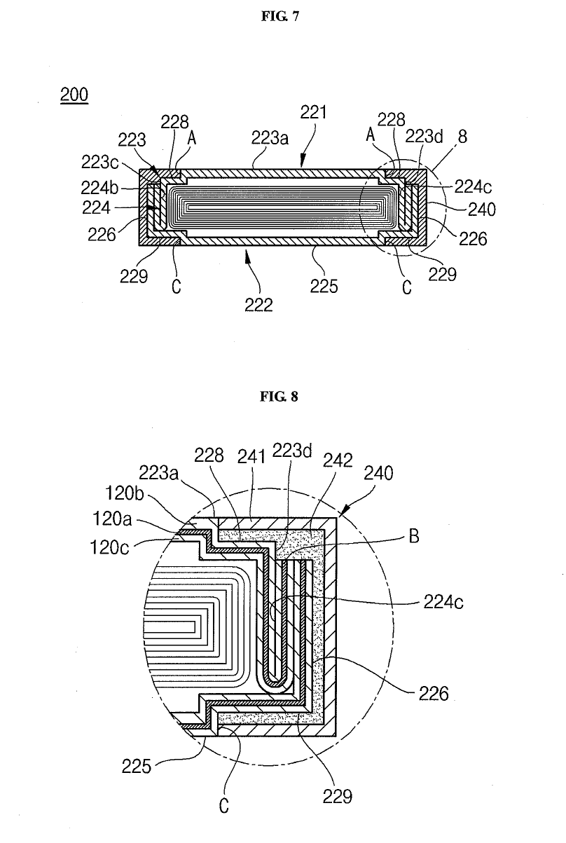

FIG. 7 is a sectional view illustrating a lithium polymer battery 200 according to another embodiment. FIG. 7 corresponds to FIG. 2. FIG. 8 is an enlarged sectional view illustrating portion (8) of FIG. 7.

The lithium polymer battery 200 of the current embodiment may include an electrode assembly 110, an outer member 220, a protective circuit module 130, and insulation tapes 240. Elements such as the electrode assembly 110 and the protective circuit module 130 of the current embodiment may be the same as those of the previous embodiment explained with reference to FIGS. 1 through 5. The same elements are denoted by the same reference numerals herein, and therefore not described.

In the lithium polymer battery 200 of the current embodiment, the insulation tapes 240 have a C-shape as shown in FIGS. 7 and 8. The insulation tapes 240 may be attached to both sides of the lithium polymer battery 200 in a manner such that the insulation tapes 240 cover upper and lower regions of both sides of the lithium polymer battery 200.

Both sides of a top surface 223a of a drawing part 223, and both sides of a finishing part 225 of a lower outer member 222 may be pressed to form recesses having a depth corresponding to the thickness of the insulation tapes 240. The top surface 223a and the finishing part 225 may be pressed individually or at the same time. First stepped parts 228 may be formed in the top surface 223a of the drawing part 223. Second stepped parts 229 may be formed in the finishing part 225 of the lower outer member 222.

A pressed depth (A) of the top surface 223a and a pressed depth (C) of the finishing part 225 may be equal to the thickness of the insulation tapes 240, and thus the thickness of the lithium polymer battery 200 does not increase although the insulation tapes 240 are attached to the top and bottom sides of the lithium polymer battery 200.

End parts of the insulation tapes 240 may be placed on the first stepped parts 228 in a manner such that folded second and third remaining parts 224b and 224c are covered by the insulation tapes 240, and then the remaining parts of the insulation tapes 240 may be attached to the second stepped parts 229.

At this time, since the insulation tapes 240 are attached to the upper and lower regions of both sides of the lithium polymer battery 200 to cover metal thin films 120a exposed along edge parts (B) of the second and third remaining parts 224b and 224c, a short circuit may be prevented between the metal thin film 120a and an external device.

Certain embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims.

What is claimed is:

1. A lithium polymer battery comprising:
an electrode assembly comprising a positive electrode, a negative electrode and a separator;
a pouch enclosing the electrode assembly, the pouch comprising a first panel and a second panel generally opposing the first panel, the first panel comprising a first main surface, the second panel comprising a second main surface opposing the first main surface, the pouch further comprising a first step formed in the first panel in a perimeter thereof and stepped from the first main surface toward the second main surface, the first step comprising a first step surface generally parallel to the first main surface; and
an insulation tape placed on the first step surface and comprising a first tape surface over the first step surface and facing away from the first step surface,
wherein the first main surface is generally planar throughout, and the insulation tape is not placed over the first main surface, and
wherein the first step and the insulation tape are sized such that the first tape surface is at a level not substantially higher than the first main surface.

2. The battery of claim 1, wherein the first step and the insulation tape are sized such that the first tape surface is at a level about the same as that of the first main surface.

3. The battery of claim 1, wherein the insulation tape has a tape thickness over the first step, wherein the first step surface has a stepping depth from the first main surface, and wherein the stepping depth is substantial with respect to the taped thickness.

4. The battery of claim 1, wherein the insulation tape comprises an insulation material layer and an adhesive layer, wherein the tape thickness comprises the total thickness of the insulation material layer and the adhesive layer, and wherein the tape thickness over the first step surface is about the same as the stepping depth.

5. The battery of claim 1, wherein the distance between the first main surface and the second main surface in a direction perpendicular to the second main surface is substantially the same as or smaller than the distance between the first tape surface and the second main surface in the direction.

6. The battery of claim 1, wherein the pouch comprises a first piece and a second piece connected together along their edges to provide the first and second panels opposing each other, wherein the first step is provided at or adjacent to an area where the first and second pieces are connected.

7. The battery of claim 1, wherein the pouch further comprises a second step stepped from the first step surface toward the second main surface, wherein the second step comprises a second step surface generally parallel to the first step surface, wherein the insulation tape is further placed on the second step surface, and wherein the insulation tape is shaped and sized such that the first tape surface over the first and second step surfaces is at a level about the same as the first main surface or slightly lower than the first main surface.

8. The battery of claim 1, wherein the pouch further comprises a third step stepped from the second main surface toward the first main surface, wherein the third step comprises a third step surface generally parallel to the second main surface, and wherein the insulation tape is further placed on the third step surface and comprises a second tape surface over the third step surface and facing away from the third step surface.

9. The battery of claim 8, wherein the third step and the insulation tape are sized such that the second tape surface is at a level about the same as the second main surface or not substantially higher or lower than the second main surface.

10. The battery of claim 8, wherein the first and third tape surfaces are overlapping when viewed in a direction perpendicular to the first main surface.

11. A method of making a battery, the method comprising:
providing a pouch for enclosing an electrode assembly, the pouch comprising a first panel and a second panel generally opposing the first panel;
forming a first step in the first panel to provide a first main surface and a first step surface stepped toward the second panel, wherein the first main surface is substantially planar throughout; and
placing an insulation tape on the first step surface such that the insulation tape has a first tape surface facing away from the first step surface, wherein the insulation tape is not placed over the first main surface, and
wherein the first step and the insulation tape are sized such that the first tape surface is at a level not substantially higher the first main surface.

12. The method of claim 11, wherein forming the first step comprises pressing a portion of the first panel such that the portion is recessed.

13. The method of claim 12, wherein the insulating tape has a tape thickness, wherein pressing forms the step at a stepping depth from the first main surface, and wherein the stepping depth is about the same as the tape thickness.

14. The method of claim 13, wherein the insulation tape comprises an insulation material layer and an adhesive layer, wherein the tape thickness comprises the total thickness of the insulation material layer and the adhesive layer, and wherein the tape thickness over the first step surface is about the same as the stepping depth.

15. The method of claim 11, wherein the distance between the first main surface and the second main surface in a direction perpendicular to the second main surface is substantially the same as or smaller than the distance between the first tape surface and the second main surface in the direction.

16. The method of claim 11, further comprising inserting an electrode assembly into the pouch, wherein the electrode assembly comprises a positive electrode, a negative electrode and a separator interposed between the positive and negative electrodes.

17. The method of claim 11, wherein providing the pouch comprises:
providing a first piece comprising a first left perimeter portion, a first right perimeter portion and the first panel interposed between the first left and right perimeter portions;
providing a second piece comprises a second left perimeter portion, a second right perimeter portion and the second panel interposed between the second left and right perimeter portions; and
welding the first left perimeter portion to the second left perimeter portion and further welding the first right perimeter portion to the second right perimeter portion, such that the first panel and second panel are opposing and generally parallel to each other;
wherein the first piece comprises two polymeric coating layers and a metallic foil interposed between the polymeric coating layers, wherein the metallic foil is exposed from the polymeric coating layers in a portion of at least one of the first left perimeter portion, the first right perimeter portion, the second left perimeter portion and the second right perimeter portion, and
wherein the insulation tape covers the exposed metallic foil.

18. The method of claim 11, further comprising
forming a second step stepped from the first step surface toward the second main surface, wherein the second step comprises a second step surface generally parallel to the first step surface, wherein forming the second step is performed simultaneously with forming the first step, and wherein the insulation tape is further placed on the second step surface and the insulation tape is shaped and sized such that the tape surface over the first and second step surfaces is at a level about the same as the first main surface or slightly lower than the first main surface.

19. The method of claim 11, further comprising forming a third step stepped from the second main surface toward the first main surface, wherein the third step comprises a third step surface generally parallel to the second main surface, wherein forming the third step is performed simultaneously with forming the first step, and wherein the insulation tape is further placed on the third step surface and the insulation tape is shaped and sized such that the tape surface over the third step surface is at a level about the same as the second main surface.
